(19) United States
(12) Patent Application Publication
(10) Pub. No.: US 2005/0048243 A1
(43) Pub. Date: Mar. 3, 2005

(54) Scented magazine blow-in with extension flap

(76) Inventor: Jeff Brown, New York, NY (US)

Correspondence Address: OSTROLENK FABER GERB & SOFFEN, 1180 AVENUE OF THE AMERICAS, NEW YORK, NY, 100368403, US

(21) Appl. No.: 10/928,864

(22) Filed: Aug. 27, 2004

Related U.S. Application Data
(60) Provisional application No. 60/499,532, filed on Sep. 2, 2003.

(51) Int. Cl. B32B 9/00

(52) U.S. Cl. 428/40.1

(57) ABSTRACT

A scented magazine blow-in which is improved by adding an additional flap to a known rectangular blow-in. An additional flap, which may have an arbitrary shape, is adhered to a rectangular flap or body. The additional flap may carry information, such as promotional information, and can be printed to have a unique or interesting appearance. The additional flap can have a container or holder, such as an envelope, which may hold a sample of a product. The additional flap may have a fold, possibly held closed by a scented adhesive, and the additional flap may cover the container or holder.

### CROSS-REFERENCE TO RELATED APPLICATIONS

This application is based upon and claims priority of U.S. Provisional Patent Application Ser. No. 60/499,532 filed by Jeff Brown on Sep. 2, 2003.

### BACKGROUND OF THE INVENTION

1. Field of the Invention

The invention relates to a scented magazine blow-in. It relates more particularly to a blow-in which may be scented and which improves upon a conventional rectangular blow-in by adding an additional flap, which may have an arbitrary shape and/or comprise a container.

2. Related Art

FIG. 1 shows a conventional blow-in 10, which has a main body 12, a first flap 14, and a second flap 16. In the conventional scented blow-in, one end or each end of the main body of the blow-in has a flap. One flap or each flap covers a coating 18 which may have a matte appearance, and which may comprise a scented material and an adhesive. When the flap 16 is lifted, as seen in FIG. 1, the adhesive releases and the scent is released. The flaps and the main body are rectangular in shape, as dictated by the requirements of today's folding and inserting machines. All of the edges must be straight, and parallel or perpendicular to each other, so that the blow-in 10 defines a rectangle whether folded or unfolded.

Likewise, the blow-in is rectangular in a case in which the blow-in has no fold (not shown).

Conventional blow-ins are about 5″ by 5″ or smaller, and are usually made of 70 lb. paper.

Other background prior art is as follows:

U.S. Pat. Nos. 3,560,025 and 4,313,557 disclose envelope inserts. The '025 patent discloses an insert for books which includes an envelope and coupons. The '557 patent discloses an envelope insert for a magazine that has uniform thickness throughout. The patent also discloses the printing of advertising and promotional material on the envelope. A portion 29 which attaches to the magazine can be made wider if desired and advertising material can be printed thereon.

U.S. Pat. Nos. 4,941,574 and 6,540,079 disclose a method for packaging small liquid samples, such as perfume. The '574 patent discloses an envelope with a protective enclosure that contains a liquid sample, meant for distribution in magazines. The '079 patent discloses a form of inexpensive packaging for distribution of, for example, perfumery.

U.S. Pat. Nos. 5,188,236 and 5,248,537 disclose a scent releasing magazine insert. The '236 patent discloses a z-shaped fold configuration for a scent sampler. The patent discloses the typical short flap used with cutting machines and does not contemplate use of the sampler with different shapes or items. The '537 patent discloses a fragrance sampler insert, to be sent with magazines, with the fragrance releasing capsule enclosed in an envelope. The scent is released only when a perforated strip is pulled away.

U.S. Pat. No. 4,430,843 discloses a cardboard envelope with a clear display panel. U.S. Pat. No. 5,992,889 discloses an advertising page having a scented material, which may be trimmed so that it is flush with the outside edge of a publication.

### SUMMARY OF THE INVENTION

There is a need to improve upon conventional magazine blow-ins to provide additional flexibility in their range of uses.

According to an aspect of the present invention, an additional flap may be adhered to an existing flap, such as a short flap, on the main body of the rectangular blow-in. The additional flap may have an arbitrary shape. In one disclosed embodiment it has the shape of a “home plate.” The attachment may be made of a heavier or different material than the conventional blow-in that it is attached to, but preferably is made of the same material, for example 70 lb. paper. It is preferably sized not to extend beyond the borders of the original flap when folded, and not beyond about 5″ by 5″, again so as to meet the requirements of conventional folding and inserting machines. It may carry additional information, for example, promotional information. It can be printed to have a unique or interesting appearance.

In addition, the attachment can itself be a container such as an envelope or a folder. For example, the attachment may be used to open the flap and release the scent, and then the user can open the envelope and take out a sample of the actual perfume. Or, a related scented or unscented product can be contained in the envelope.

Alternatively, the attachment may itself be a folder, enclosing its own adhesive and/or scent, and/or a product.

Other features and advantages of the present invention will become apparent from the following description of embodiments of the invention which refers to the accompanying drawings.

### BRIEF DESCRIPTION OF THE DRAWINGS

FIG. 1 is a perspective view of an unfolded magazine blow-in according to the known art.

FIG. 2 is a perspective view of an unfolded magazine blow-in according to a first embodiment of the invention.

FIG. 3 is a perspective view of an unfolded magazine blow-in according to a second embodiment of the invention.

### DETAILED DESCRIPTION OF PREFERRED EMBODIMENTS OF THE INVENTION

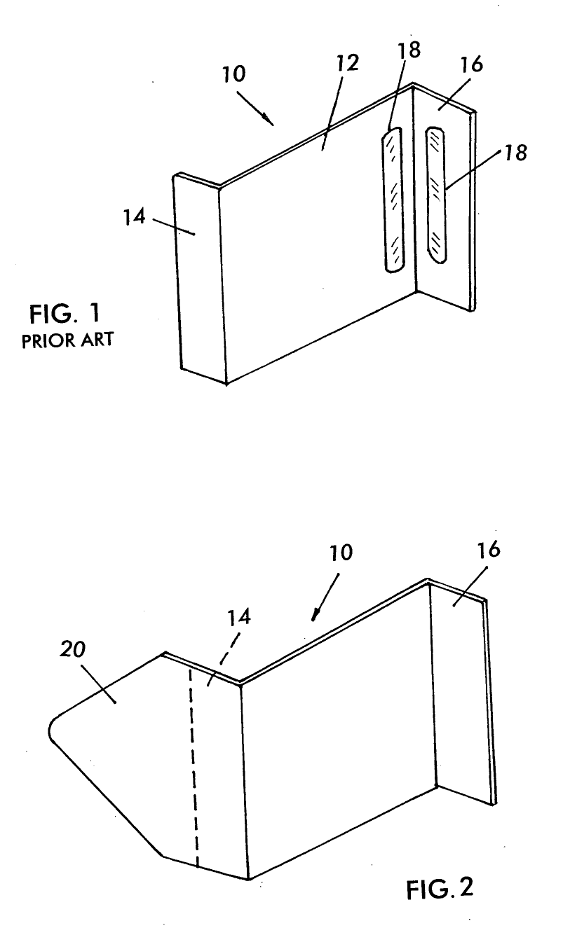

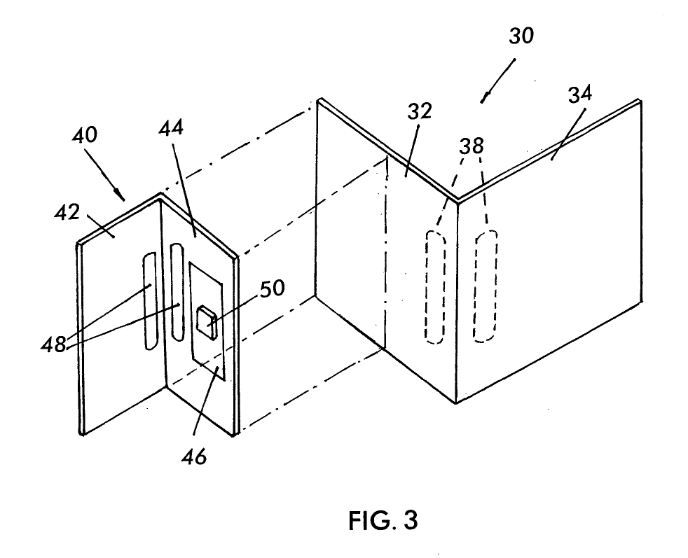

FIG. 2 shows an embodiment of the invention, in which an attachment 20 is adhered to the flap 14 of the blow-in of FIG. 1, for example with an adhesive.

FIG. 3 is an exploded view showing a further embodiment. A blow-in 30 has a front flap 32 and a back flap 34, which are held together by a scented adhesive 38 (shown in phantom) and are separable as shown in the figure to release the scent.

Adhered to the front flap 32 (by a suitable means not shown) is an attachment 40 which itself has a front flap 42, a back flap 44, and an adhesive 48, which may be scented. Affixed to the back flap 44 is a holder 46, for holding a product, decoration, or information 50. The holder 46 may be of any suitable type for holding an intended product.

Conventional folding and inserting machines typically provide for dimensions not greater than about 5″ by 5″. The blow-ins described herein will fit within those limits. Further, the same 70 lb. paper typically used in the conventional machines can also be used in these blow-ins and still be accommodated in the conventional machines.

Although the present invention has been described in relation to particular embodiments thereof, many other variations and modifications and other uses will become apparent to those skilled in the art. Therefore, the present invention is not limited by the specific disclosure herein.

1. A magazine blow-in, comprising:
a rectangular main body;
a second body adhered to the main body, the combined main and second bodies being shaped and sized for serving as a blow-in.

2. A magazine blow-in according to claim 1, wherein said second body is non-rectangular.

3. A magazine blow-in according to claim 2, wherein said second body is adhered to said main body by an adhesive.

4. A magazine blow-in according to claim 3, wherein said adhesive is scented.

5. A magazine blow-in according to claim 2, wherein said second body has a fold and a scented adhesive disposed for holding said fold closed, whereby opening the fold releases the scent.

6. A magazine blow-in according to claim 5, wherein said second body has five sides.

7. A magazine blow-in according to claim 6, wherein said second body has the shape of a home plate.

8. A magazine blow-in according to claim 1, wherein said second body is rectangular and has a fold and an adhesive disposed for holding said fold closed.

9. A magazine blow-in according to claim 8, wherein said adhesive is scented, whereby opening the fold releases the scent.

10. A magazine blow-in according to claim 1, wherein said second body has a fold and an adhesive disposed for holding said fold closed.

11. A magazine blow-in according to claim 10, wherein said second body further comprises a container capable of holding a product.

12. A magazine blow-in according to claim 11, wherein said container is enclosed by said second body when said fold is closed.

13. A magazine blow-in according to claim 1, wherein at least one of said main body and said second body has a fold, such that the blow-in has a folded condition in which the second body fits within the outer dimensions of the main body.

14. A magazine blow-in according to claim 2, wherein at least one of said main body and said second body has a fold, such that the blow-in has a folded condition in which the second body fits within the outer dimensions of the main body.

15. A magazine blow-in according to claim 1, wherein said blow-in is 5″ by 5″ or less in size.

16. A magazine blow-in according to claim 15, wherein said blow-in is made substantially of 70 lb. paper.

17. A magazine blow-in according to claim 16, wherein said blow-in is shaped and sized for being accommodated in conventional folding and inserting machines.

18. A magazine blow-in according to claim 1, wherein said blow-in is made substantially of 70 lb. paper.

19. A magazine blow-in according to claim 18, wherein said blow-in is shaped and sized for being accommodated in conventional folding and inserting machines.
